(19) United States
(12) Patent Application Publication
(10) Pub. No.: US 2026/0287922 A1
(43) Pub. Date: Sep. 24, 2026

(54) EYEWEAR WITH UNITARY LENS ATTACHMENT

(71) Applicant: Brixun Corporation dba Gatorz Eyewear, Carlsbad, CA (US)

(72) Inventors: Larry Butler, San Juan Capistrano, CA (US); Scott Melton, Yuma, AZ (US); Akash Sheth, Yuma, AZ (US)

(21) Appl. No.: 18/301,432

(22) Filed: Apr. 17, 2023

Related U.S. Application Data
(60) Provisional application No. 63/426,512, filed on Nov. 18, 2022.

(51) Int. Cl. G02C 1/02

(52) U.S. Cl. CPC G02C 1/023; G02C 2200/04

(57) ABSTRACT

An antiballistic eyewear lens coupling system and methods can include a frame, a clamp system, and a unitary lens. The clamp system can include upper and lower jaws that can be actuated by a pivot lever with a nosepiece. The unitary lens can be attached to the frame by way of the clamp system at a medial, non-optical region of the lens. The system and methods may advantageously permit easy replacement of the unitary lens, decrease optical distortion, and/or improve retention of the lens to the eyewear frame to improve the overall quality of the eyewear.

### CROSS-REFERENCE TO RELATED APPLICATIONS

This application claims the priority benefit under 35 U.S.C. § 119(e) of U.S. Provisional Patent Application No. 63/426,512, filed Nov. 18, 2022, the entirety of which is hereby incorporated by reference herein.

### BACKGROUND OF THE INVENTION

### Field Of THE Invention

This application relates generally to eyewear and specifically to antiballistic eyewear.

### Description of the Related Art

In antiballistic eyewear, the secure attachment of a lens to a frame provides many safety and performance benefits. However, many ways of securely attaching a lens to a frame can produce undesirable effects, such as degraded eyewear performance. A secure lens attachment system can tightly grasp a lens in multiple regions, sometimes bending or producing tension within the lens. This can create optical distortions in the lens or weaken the lens, increasing the risk that it may break upon impact.

Another common disadvantage in antiballistic eyewear with lenses securely attached to the frame is difficulty in replacing one lens with another lens. In many instances, an eyewear lens may need to be replaced, such as when it is scratched or otherwise damaged, or when a lens with different capabilities is needed for a particular application. For example, an antiglare lens may be needed when a user is near reflecting water, or a particular type of contrast-enhancing lens may be needed in a specific type of terrain. When a lens is securely attached, it can be difficult to remove and replace it.

### SUMMARY OF THE INVENTION

Eyewear systems and components are desired for providing high-level antiballistic capabilities while decreasing optical distortion, ease of lens replacement, difficulties in assembly, and damage to lenses or frames during assembly or use. Some embodiments disclosed in this specification achieve one or more of these advantages. Not all embodiments in this specification are antiballistic. An eyewear, such as an antiballistic eyewear, may comprise one or more of the following features:

In some embodiments, an antiballistic eyewear can include a frame with a front portion and earstems, as well as a clamp system that is separate from and attached to the frame. The clamp system can be positioned in a medial region on the front portion of the frame. The eyewear can also include a unitary lens comprising first and second viewing zones and a non-optical medial region positioned between the first and second viewing zones. This lens can be removably attachable to the frame only by way of the clamp system. In some embodiments, the frame does not contact the unitary lens in normal, non-stressed use.

The clamp system can include a plurality of jaws. An actuator can be configured to induce relative movement between the plurality of jaws. The plurality of jaws can include an upper jaw and a lower jaw. The clamp system can include a pivot lever that functionally interacts with both the upper jaw and the lower jaw. The actuator can include a nosepiece.

In some embodiments, an eyewear can include a removable unitary lens with first and second viewing zones and a non-optical medial region, each of the first and second viewing zones comprising an outer perimeter; and a frame configured to securely support the unitary lens on the head of a wearer, the lens being removably attachable to the frame by a clamp system. In a normal, unstressed, closed state in which the unitary lens is attached to the frame, the outer perimeter of the first and second viewing zones is spaced from the frame.

The clamp system can include a single actuator configured to release or secure the unitary lens. The actuator can comprise a nosepiece. In some embodiments, the frame does not extend along a bottom edge of the unitary lens. In some embodiments, the clamp system can be attached to the frame only at a region of the frame that extends along an upper region of the unitary lens. The clamp system comprises upper and lower jaws. The upper jaw can be directly attached to the frame. In some embodiments, the lower jaw is not directly attached to the frame.

In some embodiments, an eyewear includes a frame and a unitary lens, the frame extending along an upper portion of the lens and not along a lower portion of the lens; a nosepiece with downwardly extending arms; and a clamp system attached to the frame at a medial region on the frame. The downwardly extending arms of the nosepiece can extend further in left and right lateral directions than the clamp system. The lens can attach to the frame by way of the clamp system. In some embodiments, the frame does not directly contact the unitary lens.

The clamp system can comprise a plurality of jaws. The nosepiece can be part of an actuator that is configured to open and close the clamp system. The unitary lens can include first and second viewing zones. The unitary lens can include a non-optical medial region between the first and second viewing zones.

Any eyewear illustrated and/or described in this specification can be configured to be capable of withstanding or being hit by a projectile of at least about 0.15 caliber traveling at a speed of at least about 700 feet per second without shattering, penetrating through the lens, and/or dislodging or removing the lens from the eyewear frame. Any eyewear illustrated and/or described in this specification can be configured to satisfy all or at least some portion of either or both of the MIL-PRF-32432A and/or ANSI Z87.1 standards, and/or any other applicable antiballistic or other eyewear performance standard.

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

### BRIEF DESCRIPTION OF THE DRAWINGS

Various features, aspects, and advantages are described below with reference to the drawings, which are intended for illustrative purposes and should in no way be interpreted as limiting the scope of the embodiments. Furthermore, various features of different disclosed embodiments can be combined to form additional embodiments, which are part of this disclosure. In the drawings, like reference characters denote corresponding features consistently throughout similar embodiments. The following is a brief description of each of the drawings.

FIG. 1 is a front perspective view of an embodiment of an eyewear.

FIG. 2 is a rear perspective view of the eyewear of FIG. 1.

FIG. 3 is a right-side cross-sectional view taken along the medial line of the eyewear of FIG. 1 in a closed position.

FIG. 4 is a right-side cross-sectional view taken along the medial line of the eyewear of FIG. 1 in an open position.

FIG. 5 is a magnified rear perspective view of a central region of the eyewear of FIG. 1 in the open position.

FIG. 6 is a magnified right-side cross-sectional view of the eyewear of FIG. 1 showing a portion of the clamp system and surrounding components.

FIGS. 7A and 7B shows a comparison between an alternative clamp system and the clamp system of FIG. 1.

FIGS. 8A to 8C are a series of left-side views of the eyewear of FIG. 1 showing the lens being inserted and secured into place on the eyewear of FIG. 1.

### DETAILED DESCRIPTION

Various devices, methods, and components can be used in different embodiments of an eyewear. Some embodiments are illustrated in the accompanying figures; however, the figures are provided for convenience of illustration only, and should not be interpreted to limit the inventions to the particular combinations of features shown.

### Overview

This application is directed to an eyewear lens coupling system and methods that can be used during attachment of a lens to a frame and removal of the lens from the frame. As discussed in greater detail below, the devices and methods herein may, in some embodiments, advantageously decrease optical distortion of the lens during assembly and use and/or may also advantageously increase retention of the lens to the eyewear frame to improve the overall quality of the eyewear.

Any of the eyewear devices described herein may satisfy ballistic safety standard such that the eyewear may protect a user from small projectiles and fragments. In some instances, an individual may wear the eyewear while using firearms and/or while being involved in various activities where the individual's eyes or face may be exposed to small projectile fragment(s). Eyewear that satisfy the ballistic safety standards provide improved protection to a user's eyes or face in the event that a projectile strikes the eyewear. For example, military personnel may be required to use protective eyewear during combat situations. By way of other examples, individuals who work in manufacturing or construction environments or individuals who engage in recreational firearm use may also require eyewear devices that satisfy ballistic safety standards.

The ballistic safety standards require that eyewear satisfies requirements relating to various aspects of the eyewear: such as optical quality of the eyewear lens; capability of the eyewear to retain an eyewear lens within an eyewear frame when the eyewear is struck with a projectile; resistance to damage, destruction, or dislodgement of the eyewear lens when struck with a projectile; or other aspects of the eyewear. Military standard MIL-PRF-32432A identifies a performance specification for Military Combat Eye Protection (MCEP) system that provides protection from dust, flying debris, and ballistic hazards both in training and on the battlefield while maintaining compatibility with existing military equipment. American National Standards Institute (ANSI) also identifies standard Z87.1-2015 that sets forth criteria related to the description, general requirements, testing, marking, selection, care, and use of protectors to minimize or prevent injuries, from such hazards as impact, non-ionizing radiation, and chemical type injuries, in occupational and educational environments including, but not limited to, machinery operations, material welding and cutting, chemical handling, and assembly operations. As described in further detail herein, any of the devices or connections or features that are described and/or illustrated anywhere in this specification can be configured to improve assembly and attachment of an eyewear lens to an eyewear frame such that the eyewear is in compliance with all or at least some portions of the MIL-PRF-32432A standard, ANSI Z87.1 standard, and/or any other industry standard that is applicable to eyewear. For example, the eyewear may be in compliance with aspects of one or more of the industry standards that relate to ballistic testing.

For example, in some embodiments, an antiballistic eyewear can be configured to withstand impact from a ballistic projectile. In some embodiments, the eyewear can withstand at least one impact to one or both lenses of the eyewear by a projectile of at least about 0.10 caliber or at least about 0.15 caliber traveling at a speed of at least about 600 feet per second or at least about 750 feet per second, without permitting the projectile to pass through the eyewear. The eyewear, in some instances, can withstand a projectile traveling at a speed of about 700 feet per second to about 725 feet per second without permitting the projectile to pass through the eyewear. In some embodiments, the eyewear can be hit by a projectile of at least about 0.10 caliber or at least about 0.15 caliber traveling at a speed of at least about 600 feet per second or at least about 750 feet per second without shattering, penetrating through the lens, and/or dislodging or removing the lens from the eyewear frame. The impact, in some instances, may be at normal incidence (e.g., about 0 degree obliquity) to the impacted lens at a location generally within a center of the lens. For example, the impact to the lens may be at least about 0.76 cm or at least about 1 cm away from an edge of the lens and not impact the frame of the eyewear. In some embodiments, the projectile may be a 0.15 caliber, 5.85(±0.015 ) grain, T37 shaped projectile. By way of example, the eyewear may be considered to not withstand an impact(s) if one or more of the following occur: a witness sheet of the lens is perforated or if the lens is penetrated by the projectile; if the primary lens is cracked, fractured, or shattered; if one or more fragments become dislodged on the inside of the eyewear; if an eyewear component needed to retain the eyewear on a subject head form becomes completely separated from the eyewear; if a lens becomes completely separated from the frame or if the eyewear falls off the head form; if the lens delaminates and results in a loose flap of material larger than the diameter of the projectile on the rear surface of the eyewear; and if the primary lens separates from the frame to such a degree as to allow passage of a fragment projectile.

In some embodiments, an antiballistic eyewear can be configured to withstand impact from a steel projectile. The eyewear may be able to withstand at least one impact to one or both lenses of the eyewear by one or more of the following projectiles: a steel ball having a diameter of about 5.5 mm to about 6.5 mm traveling at between about 130 to about 375 feet per second; a pointed projectile weighing at least about 16.5 oz that is dropped from a height of at least about 45 in.; or a weighted needle with a total weight of at least about 1.4 oz dropped from a height of at least about 45 in. By way of example, the eyewear may be considered to not withstand an impact(s) if one or more of the following occur: any part, fragment, or material visible to the unaided eye becomes detached from the inner surface of any complete device, as determined by inspection of the device or of the contact paste; fracture; penetration of the inner surface either by the projectile passing completely through the lens, frame, or housing component, or by rupture of the inner lens surface; lens not retained; and/or the unaided eye observes any piece adhering to the contact paste, or observes contact paste on the projectile or complete device.

### Eyewear

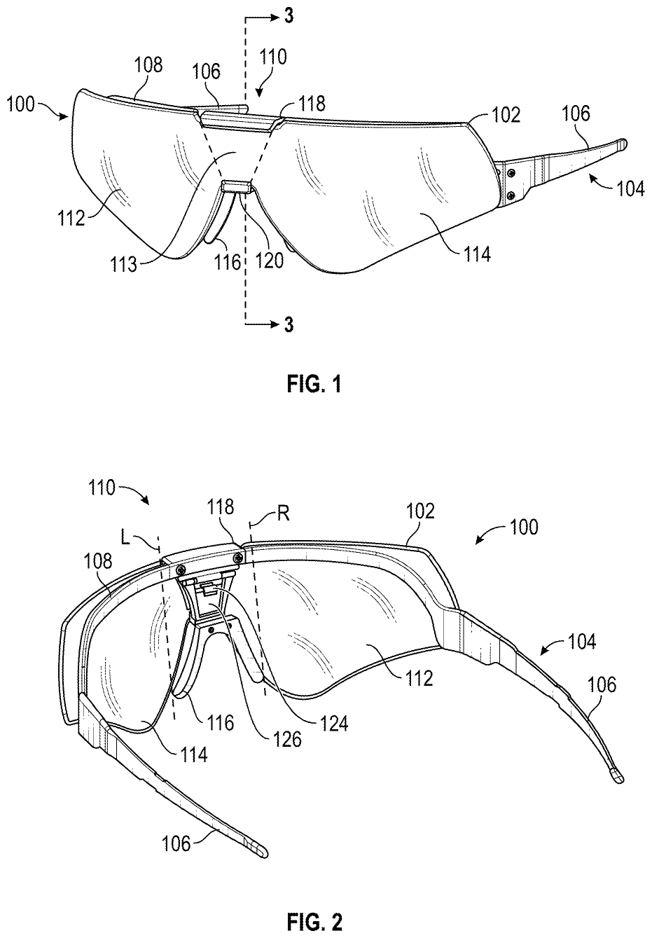

FIGS. 1 and 2 are front perspective views of an eyewear 100. The eyewear 100 can include a frame 104, a clamp system 110, and a unitary lens 102. The frame 104 can include front portion 108 and lateral portion 106. The clamp system 110 can be removably attached to the frame. The front portion 108 can be configured, when worn, to be positioned in front of, slightly above, or slightly below, the wearer's eyebrow line, or at or near the wearer's forehead, extending generally between the left and right lateral sides of the wearer's face.

The lateral portions 106 can be earstems or temples. The lateral portions 106, when worn, can extend from the respective lateral left and right ends of the front portion to respective regions on the wearer that are above and/or behind the wearer's ears. In some embodiments, as illustrated, the different portions of the frame 104 can be fixed and immovable with respect to each other. In some embodiments, one or more portions of the frame 104 can move with respect to other portions of the frame. For example, the lateral portions 106 can be movable with respect to the front portion 108, such as by way of a hinge.

As shown, in some embodiments, the frame 104 can attach to the lens 102 in only a single non-optical region of the lens 102, between and not including first and second viewing zones 112, 114 of the lens 102. The non-optical region of the lens 102 can be a medial region of the lens 102 that is not within a wearer's normal, straight-ahead field of view.

The frame 104 can be made of any material suitable to provide sufficient strength and rigidity to enable the eyewear 100 to support the lens 102 in a fixed, secure, and safe position on the head of the wearer. In some embodiments, the frame 104 is made of one or more metals (e.g., stainless steel, cobalt chromium, titanium, monel, beryllium, aluminum, etc., or an alloy combination including any of these metals). Frames 104 that include metal material may provide various advantages: such as high durability, strength, resistance to scratching, snapping, chipping, and/or breaking, resistance to corrosion, resilience, etc. In certain instances, frames 104 made of metal material may provide particular advantages in situations involving ballistics, such as military combat situations, manufacturing environments, or for recreational firearm usage. The metal material may provide high durability of the eyewear when exposed to small projectile fragment(s). For example, high rigidity and durability due to a metal material may further inhibit disconnection of the coupling between the frame connection and the lens connection. In some embodiments, the frame 104 may be formed of a polymer or plastic (e.g., carbon fiber, xylonite, cellulose acetate, cellulose acetate propionate, or blended nylon). Frames 104 that include polymer or plastic material may provide various advantages: such as increased malleability or deformability during assembly of the lens 102 to the frame 104, decreased cost, decreased weight of the frame, increased variety in colors and style, etc.

In the illustrated example, the lateral portions 106 of the frame 104 can be narrow, approximately the same width as the front portion 108 of the frame of the eyewear. Narrow lateral portions 106 can provide low weight and a small amount of contact against the wearer's face. As shown, in some embodiments, the shape of the lens 102 and/or the frame 104 can be configured to orient the lens 102 to include a wrapped shape to closely conform to a user's face and head, and/or a degree of pantoscopic tilt or “rake” whereby the lower edge of the frame orbitals and/or lenses can tilt inwardly more toward the face than the upper edge of the frame orbitals and/or lenses to closely conform to a user's face. The shape of the eyewear, including the orientation of the lens 102, can resist the formation of large or significant gaps between the eyewear 100 and the user's face during use which may otherwise increase the likelihood that light and/or projectiles or debris may contact the user's eyes or face through a space between the eyewear and the user's head.

The vertical and/or horizontal thickness of the front portion 108 of the frame 104 can be generally consistent across the frame 104, from the juncture between the front portion 108 and the left lateral portion 106 to the juncture between the front portion 108 and the right lateral portion 106. As shown, in the medial region where the front portion 108 of the frame 104 is attached to the clamp system 110, the vertical and/or horizontal thickness of the front portion 108 of the frame 104 can be about the same as the vertical and/or horizontal thickness of the front portion 108 of the frame 104 immediately adjacent on the left and/or right from where the clamp system 110 is attached to the front portion 108 of the frame 104. In some embodiments, consistency in thickness (e.g., not narrowing the thickness of the frame 104) in the region where the clamp system 110 is attached can provide strength and resistance to damage upon ballistic impact.

In some embodiments, as shown, the frame 104 is configured to securely support the lens 102 on the frame 104 such that the first and second viewing zones 112, 114 of the lens 102 cover and protect the user's eyes, even during and after a ballistic impact against the lens 102 of any of the types described in this specification. As illustrated in FIG. 2, the frame 104 can be attached to the lens 102 with a clamp system 110 that is removably affixed to the frame 104, such as by connectors (e.g., one or more screws, pins, rivets, etc.). The clamp system 110 can be positioned in a medial region of the eyewear 100, between left and right regions of the front portion 108 of the frame 104. As shown, the clamp system 110 can be configured to receive and secure a lens 102 at only a medial, non-optical region 113 of the lens 102, between the first and second viewing zones 112, 114 of the lens 102. In some embodiments, the frame 104 and the lens 102 are attached to each other solely at the medial region of the frame 104 and the medial non-optical region 113 of the lens 102. The frame 104 and the lens 102 can be configured to contact each other in a normal, non-stressed position only via the clamp system 110 at the medial region of the frame 104 and the medial non-optical region 113 of the lens 102. For example, the frame 104 and lens 102 can be shaped, oriented, and/or configured such that there is no contact between the frame 104 and the lens 102 in a normal, non-stressed state anywhere along the periphery of each of the first and second viewing zones 112, 114 of the lens 102.

As shown in FIG. 2, the front portion 108 of the frame 104 can be positioned such that it does not contact and/or is entirely behind and/or entirely below the upper edge of the lens 102 across all of the periphery or perimeter of the first and second viewing zones 112, 114. In some embodiments, as illustrated, no portion of the frame 104 extends above the uppermost portion of the lens 102. As shown, in some embodiments, the frame 104 can extend along and behind only an upper edge or region of the lens 102 and not along or behind a lower edge or region of the lens 102. In some embodiments, a majority of the vertical thickness of the front portion 108 of the frame 104 is positioned below and along the upper edge of the lens 102 when attached.

In a normal, unstressed, closed state, the entire perimeter of the first and second viewing zones 112, 114 of the lens 102 can be spaced from the frame 104. For example, a gap can exist between the upper anterior region of the lens 102 across each of the first and second viewing zones 112, 114 and the front portion 108 of the frame 104. As shown, in some embodiments, the frame 104 does not surround the lens 102 and does not contact the lens 102 except by way of the clamp system located only at a medial region of the frame 104. In some embodiments, no part of the first and second viewing zones 112, 114 is received in a channel within the frame 104 or within any other component of the eyewear 100 or attached to or in contact with the frame 104. In some embodiments, in a normal, unstressed, closed state, the frame 104 does not contact or extend along the lens 102 at any point on the bottom edge of the lens 102. In some embodiments, the frame 104 does not contact or extend along the lens 102 at any point on the lateral sides of the lens 102. In some embodiments, as shown, there is no contact between the frame 104 and the lens 102 at any point in normal, unstressed, closed use that is more lateral on either side of a medial plane of the eyewear 100 than the respective left and right lateral reach of the respective arms of the nosepiece of the eyewear 100. In some embodiments, in a closed state there is no contact between the frame 104 and the lens 102 along the respective lower edges of each of the first and second viewing zones 112, 114 of the lens 102, along the respective lateral edges of each of the first and second viewing zones 112, 114 of the lens 102, and/or along the respective upper edges of each of the first and second viewing zones 112, 114 of the lens 102. In some embodiments, the non-optical medial region 113 of the lens 102, which as illustrated is positioned directly above and not extending laterally beyond the respective left and right lateral positions of the nosepiece, is the only portion of the lens 102 that is affixed to the frame 104 (by way of the clamp system 110). The eyewear 100 can be configured such that the lens 102 can be removably secured and/or removably affixed to the frame 104 in a safe, antiballistic manner while avoiding optical distortions in the lens 102 and while avoiding stresses otherwise induced in the lens 102 by the conventionally tight or opposing multi-region contact between the lens 102 and the frame 104. In some embodiments, as illustrated, providing a space between the first and second viewing zones 112, 114 and the front portion 108 of the frame 104 can help resist damage to the lens 102 in a ballistic event. The space between the viewing zones 112, 114 and the frame 104 can permit the lens 102 to flex in a rearward direction upon impact with an object on the front side of the lens 102. This flexing of the lens 102 can help decelerate the object over a larger distance and time than if the lens 102 were rigidly attached to the frame 104 around the viewing zones 112, 114, thereby dissipating the transfer of kinetic energy between the object and the lens 102.

In the example of eyewear shown in the figures, the frame 104 extends along and behind only the upper and lateral edges of the eyewear 100, not along or near the bottom edge of the eyewear 100. As illustrated, there is a single connection between the left lateral portion 106 of the frame 104 and the right lateral portion 106 of the frame 104, which is via the front portion 108 of the frame 104 along the upper edge or region of the eyewear 100, not along any lower edge or region of the eyewear 100. However, in some embodiments (not shown), one or more lens-receiving regions can include orbitals that are closed, integral, and unitary with the rest of the front face of the eyewear. A closed orbital can be a loop formed of one or more separate pieces connected together (not shown). Orbitals can be integral in that they can be formed of a single piece of material, without requiring connectors to attach components of the orbital to each other during insertion or removal of a lens. Orbitals can be unitary with the rest of the front face of the eyewear in that they can be formed of a single piece of material with the rest of the front face of the eyewear, without requiring connectors to attach the orbitals to the rest of the front face of the eyewear. Many other structures and configurations can be used instead of or in addition to those illustrated in the examples. Any suitable lens-supporting structure can be used.

The example of eyewear 100 shown in the figures has a unitary lens 102 (which in some embodiments may also be an optical shield, a helmet shield, a protective face shield, etc.), but anything shown or described in this specification can be used in any other eyewear with appropriate modifications, such as in a dual-lens eyewear. The first and second viewing zones 112, 114 of the lens 102 can be highly curved and sufficiently wide in the vertical and horizontal dimensions to cover a user's natural field of vision from both eyes. As shown, the medial, non-optical region 113 can be made of the same material and have the same surface appearance as the first and second viewing zones 112, 114, and can be substantially narrower in the vertical dimension than the smallest vertical dimension of the first and second viewing zones 112, 114. In some embodiments, the lens 102 can be made of a single material in the first and second viewing zones 112, 114 and the medial non-optical region. As shown, the non-optical medial region can be transparent. In use, the medial, non-optical region 113 of the lens 102 can be positioned directly above the wearer's nose. In some embodiments, as shown, the medial, non-optical region 113 can have an upper edge that is wider than a lower edge, such that vertical lines (imaginary, in the illustrated embodiment) connecting the upper and lower edges are slanted.

As illustrated, in some embodiments, the lens 102 can be shaped with a generally straight, generally horizontal upper edge. The upper edge can include a small notch configured to more easily fit within the clamp system 110 of the eyewear 100. The lower edge of the lens 102 can be curved. The lower edges of each of the respective viewing zones 112, 114 of the lens 102 can include two slanted regions that converge at a lower curved region. One of the slanted regions can be positioned on a medial side of each viewing zone 112, 114, and one of the slanted regions can be positioned on a lateral side of each viewing zone 112, 114. In the illustrated example, the lateral slanted region of each of the viewing zones 112, 114 can be longer than the medial side of each viewing zone.

The lens 102 used in the eyewear 100 can be of any suitable type: plano, prescription, spherical, cylindrical, toroidal, light-attenuating, UV-protecting, polarized, molded to shape, cut from lens blanks, interference-layer coated, anti-scratch, antiglare, antireflective, antifog, and/or any other type of lens 102. In some embodiments, the lens 102 is formed of a suitable anti-shatter, antiballistic material such as plastic (e.g., polycarbonate), glass, or any other material suitable for a particular application or use.

### Coupling

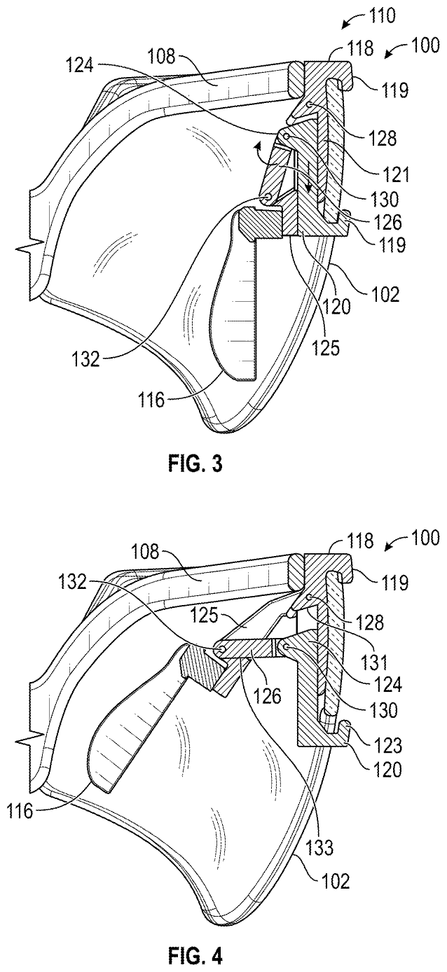

As shown in FIGS. 3-5, the clamp system 110 can be configured to removably affix or secure the lens 102 to the frame 104 in a safe, antiballistic manner in partial or full compliance with any of the industry specifications. The lens 102 can be removed and/or inserted quickly, without the use of tools, and/or without requiring bending, moving, or opening of separate portions of the frame 104 that are positioned above and below the upper and lower edges of the view zones 112, 114 of the lens 102. Rather, as illustrated, the clamp system 110 can be configured to removably affix or secure the lens 102 to the frame 104 only at the medial non-optical region of the lens 102.

As shown in FIG. 3, the clamp system 110 can comprise an upper jaw 118, a lower jaw 120, an actuator 116, a pivot lever 125, and a connector 126. The upper jaw 118 can be removably affixed to the front portion 108 of the frame 104, such that the upper jaw 118 does not move with respect to the frame 104 in normal use. As shown, the upper edge of the upper jaw 118 can be configured to be positioned in general co-linear alignment with the upper edge of the lens 102 when the lens 102 is removably coupled with the eyewear 100. The upper jaw 118 can include a downwardly facing groove forming a concavity configured to receive an upper edge of the medial non-optical region 113 of the lens 102. The thickness of the groove (in an anterior to posterior direction) can correspond to or be about the same size as the thickness of the lens 102 along the upper edge of the lens 102. An anterior guard 119 in the upper jaw 118 is configured to extend downwardly in front of an upper edge of the lens 102 when coupled together. A support 121 of the upper jaw 118 is configured to be positioned behind and in contact with the medial non-optical region 113 of the lens 102 to support the lens 102 from behind in use.

In some embodiments, the clamp system 110 can have approximately the same width and/or not be larger than about the largest horizontal width dimension of the non-optical medial region 113 of the lens 102 (see, e.g., FIG. 2). The farthest left and right lateral points on the descending arms of the nosepiece on the actuator 116 can define imaginary vertical lines L and R as shown in FIG. 2. The largest horizontal width dimension of the clamp system 110 can be less than or equal to about the horizontal distance between lines L and R. In some embodiments, as shown in FIG. 2, the clamp system 110 can extend left and right laterally from the medial plane of the eyewear 100 no more than about the respective left and right lateral reach of the respective arms of the nosepiece of the eyewear 100.

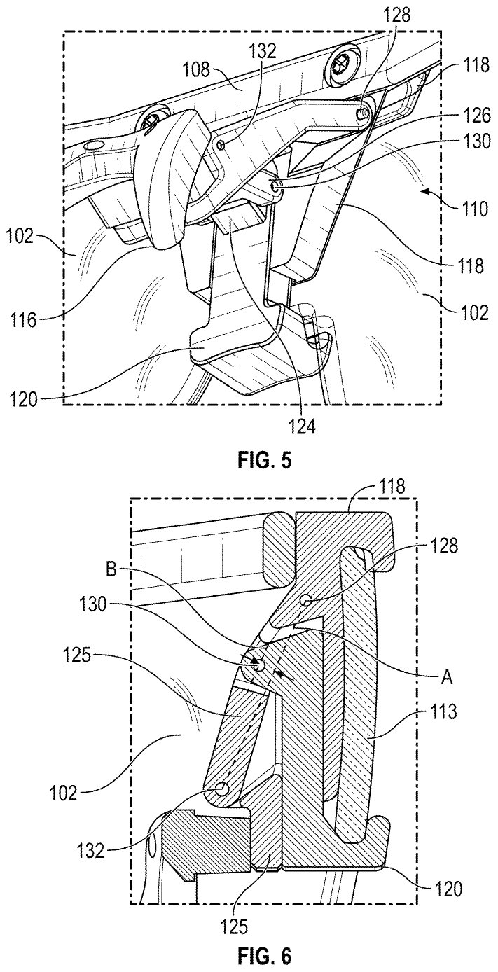

As shown in FIG. 5, the lower jaw 120 is slidably received within a vertical channel in the upper jaw 118. Both the vertical channel of the upper jaw 118 and the lower jaw 120 itself are wider in an anterior region than in a posterior region, producing a corresponding posterior-to-anterior widening taper in each component between these regions. During assembly, the lower jaw 120 is inserted into the bottom of the vertical channel of the upper jaw 118 in an upward direction rather than inserting the lower jaw 120 from the rear of the vertical channel in the upper jaw 118. Due to the taper, in the illustrated embodiment, the lower jaw 120 is restrained from exiting the channel through the rear but instead can only move up and down within the channel. The lower jaw 120 can include an upwardly facing groove forming a concavity configured to receive a lower edge of the medial non-optical region 113 of the lens 102. The thickness of the groove (in an anterior to posterior direction) can correspond to or be about the same size as or slightly larger than the thickness of the lens 102 along the lower edge of the lens 102. An anterior guard 123 in the lower jaw 120 is configured to extend upwardly in front of a lower edge of the lens 102 when coupled together. As shown in FIG. 1, the bottom edge of the lower jaw 120 is substantially narrower than the top edge of the upper jaw 118. In some embodiments, the bottom edge of the lower jaw 120 is narrower than the distance between the downwardly descending arms of the nosepiece of the actuator 116. The bottom edge of the lower jaw 120 can be slightly curve in a concave manner.

Returning to FIGS. 3-4, the pivot lever 125 can be directly pivotally attached to an upper posterior side of the upper jaw 118 at a pivot point 128, and the pivot lever 125 can be indirectly pivotally attached to the lower jaw 120 via the connector 126 at a first pivot point 132 and a second pivot point 130. As shown in FIG. 2, the pivot lever 125 can have a forked shape with a plurality of tines, each tine configured to be positioned on opposing sides of the upper portion of the upper jaw 118. An actuator 116 can be securely affixed to the pivot lever 125. As shown in FIG. 2, the connector 126 can have a forked shape on its upper edge with a plurality of tines, each tine configured to be positioned on opposing sides of the upper end 124 of the lower jaw 120. Each of the pivot points 128, 130, 132 can be created by providing aligned bores in each of the respective pairs of pivoting parts and inserting pivot pins through the bores. Each pivot pin can include an enlarged head or other friction-inducing surface to retain the pivot pin within the respective bore.

The actuator 116 can be configured to be grasped by a user and rotated rearwardly and upwardly along a generally curved or circular path as shown, transitioning the eyewear from the closed state as shown in FIG. 3 to the open state as shown in FIG. 4. The actuator 116 can be sized and shaped so as to function also as a nosepiece for the eyewear 100 when in the closed position as shown in FIG. 3, with first and second downwardly descending arms (see FIG. 2) that are configured to be positioned in contact with respective sides of a wearer's nose during use. As shown, a single actuator 116 can be utilized to open and close the clamp system 110 to respectively release or secure the entire lens 102, including both left and right viewing zones 112, 114 at the same time.

When the actuator 116 is rotated rearwardly and upwardly as indicated in FIG. 3, the pivot lever 125 rotates with respect to the upper jaw 118 about pivot point 128. Simultaneously, as the actuator is raised, a first end of the connector 126 rotates with respect to the pivot lever 125 about pivot point 132, exerting an upward and rearward force on the first end of the connector 126. Simultaneously, as the first end of the connector 126 is raised upwardly and rearwardly, the second end of the connector 126 rotates with respect to the lower jaw 120 about pivot point 130, exerting a downward force on the upper end 124 of the lower jaw 120 and moving the lower jaw 120 in a downward direction. The lower jaw 120 is restrained against posterior and anterior movement by the tapered channel in the upper jaw 118 (see FIG. 5). The rearward rotation of the actuator 116 is restrained by abutting contact between the connector 126 and the stop 133 on the pivot lever 125. In the restrained position (e.g., when the eyewear 100 is open as shown), the orientation of the actuator 116 with respect to a vertical tangent along the anterior surface of the lens 102 is about 45 degrees. In some embodiments, this orientation can be less than or equal to about 90 degrees.

As shown in FIGS. 3 and 4, the rotation of the actuator 116 from the closed state to the open state creates a small gap between the bottom edge of the lens 2 and the groove of the lower jaw 120. As illustrated, the gap is larger than the distance from the bottom of the groove of the lower jaw 120 to the top of the anterior guard 123 of the lower jaw 120, permitting the bottom edge of the lens 2 to be rotated outward in an anterior direction and then permitting the bottom edge of the lens 2 to be pulled downward (at an angle) to withdraw the top edge of the lens 102 from the groove in the upper jaw 118.

FIG. 6 illustrates that an imaginary line A can extend between the respective centers of the pivot points 132 and 128, the points at which respectively the pivot lever 125 rotates with respect to the connector 126 and at which the pivot lever 125 rotates with respect to the upper jaw 118. Another imaginary line B can be parallel to line A and extend through the center of the pivot point 130 at which the connector 126 rotates with respect to the lower jaw 120. In some embodiments, as illustrated, the distance between lines A and B can be at least about 0.04 inches. An angle formed between line A and an imaginary horizontal line extending along the bottom of lower jaw 120 can be acute, less than 90 degrees. In some embodiments, either or both of these features can help to reduce a binding effect in the closed state which could otherwise require an inconveniently high force to move the actuator 116 from the closed to the open state.

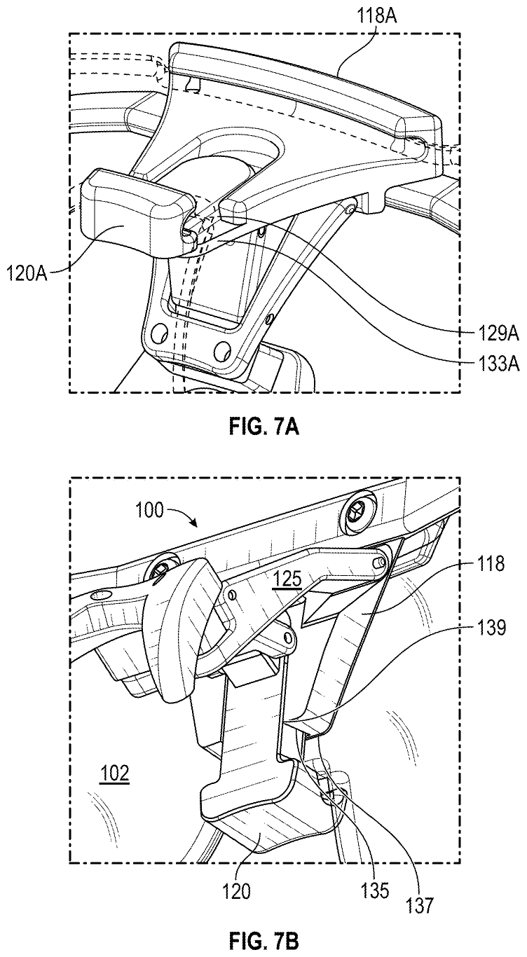

As shown in FIG. 7A, an alternative design can provide tapering surfaces 129A between the upper jaw 118A and the lower jaw 120A which are narrower on the posterior side than on the anterior side, in which case a posterior retaining wall 133A can be provided to retain the lower jaw 120A within the upper jaw 118A. In contrast, by providing a tapering surface 135 in eyewear 100 that is wider on the anterior edge 137 than on the posterior edge 139 (as shown in the embodiment in FIG. 7B and in other remaining figures), the retaining wall 133A can be eliminated, thereby permitting the respective sliding surfaces of the upper jaw 118 and lower jaw 120 to be thicker for increased bearing interface and enabling the region where the respective sliding surfaces contact to be closer to the pivot axis of the pivot lever 125 with respect to the upper jaw 118.

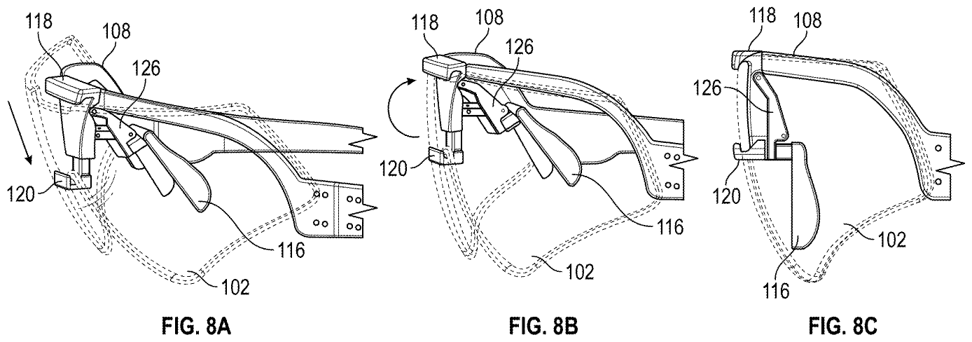

As shown in FIGS. 8A to 8C, a lens 102 can be inserted into an open frame 104. A bottom edge of the lens 102 can be inserted into the groove in the lower jaw 120 and then the top edge of the lens 102 can be rotated rearward until it abuts against the support 121 of the upper jaw 118 and is positioned into vertical alignment with the groove of the upper jaw 118.

The frame 104 can freely transition back from the open state as shown in FIG. 4 to the closed state as shown in FIG. 3 when a user pushes downward on the actuator 116, forcing the lower jaw 120 upward until the upper end 124 of the lower jaw 120 abuts against a stop 131 of the lower jaw 120 as shown in FIG. 3. The stop 131 can be slanted or tapered such that it extends further downward on the posterior side than on the anterior side, permitting the plane of the bearing surfaces between the upper jaw 118 and lower jaw 120

In the closed position, the actuator 116 can be configured to resist rearward movement, requiring a significantly higher initial force to “unlock” the actuator 116 by pushing it backward than is required to continue pushing the actuator 116 backward once the motion has begun. This “lock” can be created by the combined friction between the second end of the connector 126 against the upper end of the lower jaw 120 and the friction between the lower jaw 120 and the upper jaw 118.

In some embodiments, an eyewear without a lens can be provided, or a lens without an eyewear can be provided, and a user can be instructed to attach or couple an eyewear to a lens, or a lens to an eyewear, in any manner that is illustrated and/or described anywhere in the drawings and/or text of this application. The attachment or coupling, as described herein, may be sufficient to satisfy fully or at least some criteria and performance standards set forth in the military standard MIL-PRF-32432A and/or the ANSI Z87.1 standard or in any other applicable eyewear performance standard.

### Variations

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1” includes “1.” Phrases preceded by a term such as “substantially,” “generally,” and the like include the recited phrase and should be interpreted based on the circumstances (e.g., as much as reasonably possible under the circumstances). For example, “substantially spherical” includes “spherical.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Although certain embodiments and examples have been described herein, it should be emphasized that many variations and modifications may be made to the elbow joint prosthesis shown and described in the present disclosure, the elements of which are to be understood as being differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of the inventions extends beyond the specifically disclosed embodiments to any and all embodiments having equivalent elements, modifications, omissions, combinations or sub-combinations of the specific features and aspects of the embodiments (e.g., of aspects across various embodiments), adaptations and/or alterations, and uses of the inventions as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

Any methods disclosed herein need not be performed in the order recited. The methods disclosed herein include certain actions taken by a practitioner; however, they can also include any third-party instruction of those actions, either expressly or by implication.

1. An antiballistic eyewear comprising:
a frame with a front portion and earstems;
a clamp system that is positioned in a medial region on the front portion of the frame; and
a unitary lens comprising first and second viewing zones and a non-optical medial region positioned between the first and second viewing zones, the unitary lens being integrally formed and removably attached to the frame by the clamp system contacting the unitary lens only in the non-optical medial region of the unitary lens.

2. The antiballistic eyewear of claim 1, wherein the frame does not contact the unitary lens when the clamp is closed on the lens and the eyewear is in an unworn state.

3. The antiballistic eyewear of claim 1 wherein the clamp system comprises a plurality of jaws.

4. The antiballistic eyewear of claim 3 wherein the clamp system comprises an actuator configured to induce relative movement between the plurality of jaws.

5. The antiballistic eyewear of claim 4 wherein the actuator includes a nosepiece.

6. The antiballistic eyewear of claim 4 wherein the plurality of jaws comprises an upper jaw and a lower jaw.

7. The antiballistic eyewear of claim 6 wherein the clamp system includes a pivot lever that functionally interacts with both of the upper jaw and the lower jaw.

8. An eyewear with a removable lens, the eyewear comprising:
a unitary lens with first and second viewing zones and a non-optical medial region, the unitary lens being integrally formed and each of the first and second viewing zones comprising an outer perimeter; and
a frame configured to securely support the unitary lens on a head of a wearer, the unitary lens being removably attachable to the frame by a clamp system;
wherein in a closed state in which the unitary lens is attached to the frame, the outer perimeter of the first and second viewing zones is spaced from the frame.

9. The eyewear of claim 8, the clamp system comprising a single actuator configured to release or secure the unitary lens.

10. The eyewear of claim 9, wherein the single actuator comprises a nosepiece.

11. The eyewear of claim 9, wherein the frame does not extend along a bottom edge of the unitary lens.

12. The eyewear of claim 11, wherein the clamp system is attached to the frame only at a region of the frame that extends along an upper region of the unitary lens.

13. The eyewear of claim 12, wherein the clamp system comprises an upper jaw and a lower jaw.

14. The eyewear of claim 13, wherein the upper jaw is directly attached to the frame.

15. The eyewear of claim 14, wherein the lower jaw is not directly attached to the frame.

16. An eyewear comprising:
a frame and a unitary lens including integrally formed first and second viewing zones and a connecting medial region, the frame extending along an upper portion of the unitary lens and not along a lower portion of the unitary lens;
a nosepiece with downwardly extending arms; and
a clamp system attached to the frame at a medial region on the frame, the downwardly extending arms of the nosepiece extending further in left and right lateral directions than the clamp system;
wherein the unitary lens attaches to the frame by way of the clamp system.

17. The eyewear of claim 16, wherein the frame does not directly contact the unitary lens.

18. The eyewear of claim 17, wherein the clamp system comprises a plurality of jaws.

19. The eyewear of claim 18, wherein the nosepiece is part of an actuator that is configured to open and close the clamp system.

20. The eyewear of claim 16, wherein the unitary lens comprises first and second viewing zones.

21. The eyewear of claim 20, wherein the unitary lens comprises a non-optical medial region between the first and second viewing zones.
